(19) United States
(12) Patent Application Publication
(10) Pub. No.: US 2009/0189118 A1
(43) Pub. Date: Jul. 30, 2009

(54) Liquid Maleated Butyl Rubber

(75) Inventors: Rui Resendes, Kingston (CA); John Scott Parent, Kingston (CA); Ralph Allen Whitney, Kingston (CA)

Correspondence Address: Jennifer R. Seng;LANXESS Corporation, Law & Intellectual Property Department, 111 RIDC Park West Drive, Pittsburgh, PA, 15275-1112, US

(73) Assignees: LANXESS INC., PITTSBURGH, PA (US); QUEEN'S UNIVERSITY OF KINGSTON, KINGSTON, ON (CA)

(21) Appl. No.: 11/922,546

(22) PCT Filed: Jul. 6, 2006
(86) PCT No.: PCT/CA2006/001115

§ 371 Date: Mar. 5, 2009

Related U.S. Application Data
(60) Provisional application No. 60/698,252, filed on Jul. 11, 2005.

(51) Int. Cl. C09K 3/00

(52) U.S. Cl. 252/183.11

(57) ABSTRACT

The present invention relates to a grafted liquid polymer comprising a polymer of a C₄ to C₇ monoolefin monomer and a C₄ to C₁₄ multiolefin monomer, a grafting material and a free radical initiator and to a process for the preparation of the grafted liquid polymer. More specifically, a liquid maleated butyl rubber composition is disclosed. The present invention also relates to grafted liquid polymer compositions which are curable in the presence of multifunctional amines. The compositions of the invention are used in a variety of applications, including injection molded fuel cells gaskets, adhesives, sealants or as polyurethane substrates.

### FIELD OF THE INVENTION

The present invention relates to liquid maleated butyl rubber compositions. The present invention also relates to a process for the preparation of liquid maleated butyl rubber compositions. The present invention also relates to liquid maleated butyl rubber compositions which are curable in the presence of multi-functional amines.

### BACKGROUND OF THE INVENTION

Butyl rubber (a copolymer of isobutylene and a small amount of isoprene) is known for its excellent insulating and gas barrier properties. In many of its applications, butyl rubber is used in the form of cured compounds. Vulcanizing systems usually utilized for this polymer include sulfur, quinoids, resins, sulfur donors and low-sulfur high performance vulcanization accelerators.

It is well known that the radical polymerization of isobutylene is impractical as a result of the intrinsic auto-inhibition mechanism present in this system. In fact, the initiation of isobutylene in the presence of a radical source is rapid. However, the polymerization rate constant (kₚ) is quite small and the preferred reaction pathway (inhibition, kᵢ) involves the abstraction of allylic hydrogens from an isobutylene molecule (kᵢ>>kₚ).

It is also well known that butyl rubber and polyisobutylene decompose under the action of organic peroxides. Furthermore, U.S. Pat. Nos. 3,862,265 and 4,749,505 teach that copolymers of a C₄ to C₇ isomonoolefin and up to 10 wt. % isoprene or up to 20 wt. % para-alkylstyrene undergo molecular weight decrease when subjected to high shear mixing. The effect is enhanced in the presence of free radical initiators.

White et al. (U.S. Pat. No. 5,578.682) claimed a post-polymerization process for obtaining a polymer with a bimodal molecular weight distribution derived from a polymer that originally possessed a monomodal molecular weight distribution. The polymer, e.g., polyiso-butylene, a butyl rubber or a copolymer of isobutylene and paramethyl-styrene, was mixed with a polyunsaturated crosslinking agent (and, optionally, a free radical initiator) and subjected to high shearing mixing conditions in the presence of organic peroxide.

Similarly, the maleation of polyolefins is a well known process which has been used in the preparation of maleated materials (such as maleated polyethylene) which possess improved levels of interaction with siliceous and/or clay fillers. The preparation of these materials can be achieved with the use of a reactive extrusion apparatus in which the polymeric substrate is admixed with maleic anhydride and a peroxide initiator.

### SUMMARY OF THE INVENTION

It has now been surprisingly discovered that by combining the radical degradation of butyl rubber (IIR) with peroxide initiated maleation, it is possible to simultaneously reduce the molecular weight of IIR and cause its maleation, resulting in a chemically similar but physically different liquid material with anhydride functionalities. It has further surprisingly been discovered that it is possible to cure these materials in the presence of diamines or diols.

The present invention relates to a grafted liquid polymer containing a polymer of a C₄ to C₇ monoolefin monomer and a C₄ to C₁₄ multiolefin monomer, a grafting material and a free radical initiator.

The present invention also relates to a process for grafting a polymer including reacting a polymer of a C₄ to C₇ monoolefin monomer and a C₄ to C₁₄ multiolefin monomer in the presence of a grafting material and a free radical initiator.

The present invention also relates to a process for degrading a non-liquid polymer to a grafted liquid polymer, the process comprising reacting the non liquid polymer of a C₄ to C₇ monoolefin monomer and a C₄to C₁₄ multiolefin monomer in the presence of a grafting material and a free radical initiator to form the grafted liquid polymer.

The present invention also relates to a process for preparing a cured compound comprising reacting a polymer of a C₄ to C₇ monoolefin monomer and a C₄ to C₁₄ multiolefin monomer in the presence of a grafting material and a free radical initiator to form a grafted liquid polymer and then curing the grafted liquid polymer in the presence of a multifunctional amine curing agent.

### BRIEF DESCRIPTION OF THE DRAWINGS

FIG. 1 illustrates the radical polymerization of isobutylene. For reference, the bond dissociation energies for aliphatic, vinylic and allylic hydrogens are included.

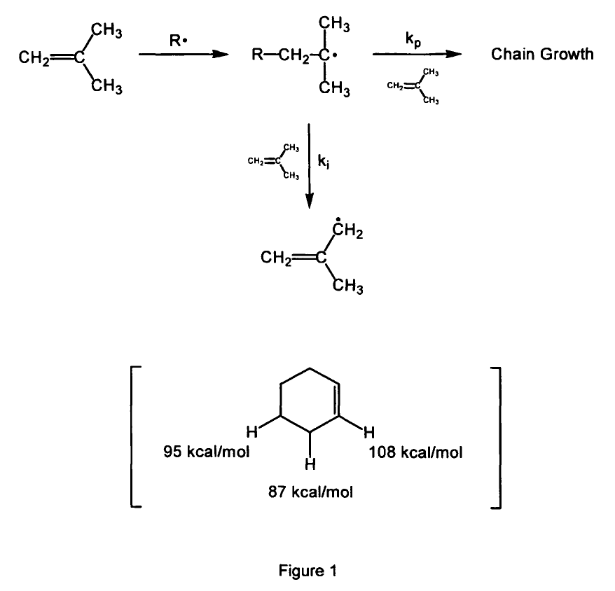

FIG. 2 illustrates the curing of maleic anhydride functionalized IIR in the presence of diamines.

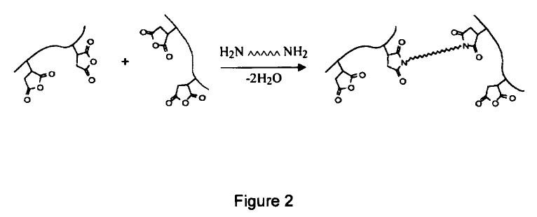

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.” Also, all ranges include any combination of the maximum and minimum points disclosed and include any intermediate ranges therein, which may or may not be specifically enumerated herein.

The present invention relates to butyl polymers. The terms “butyl rubber”, “butyl polymer” and “butyl rubber polymer” are used throughout this specification interchangeably. Suitable butyl polymers according to the present invention are derived from a monomer mixture containing a C₄ to C₇ monoolefin monomer and a C₄ to C₁₄ multiolefin monomer.

Preferably, the monomer mixture contains from about 80% to about 99% by weight of a C₄ to C₇ monoolefin monomer and from about 1.0% to about 20% by weight of a C₄ to C₁₄ multiolefin monomer. More preferably, the monomer mixture contains from about 85% to about 99% by weight of a C₄ to C₇ monoolefin monomer and from about 1.0% to about 15% by weight of a C₄ to C₁₄ multiolefin monomer. Most preferably, the monomer mixture contains from about 95% to about 99% by weight of a C₄ to C₇ monoolefin monomer and from about 1.0% to about 5.0% by weight of a C₄to C₁₄ multiolefin monomer.

The preferred C₄ to C₇ monoolefin monomer may be selected from isobutylene, homopolymers of isobutylene, 2-methyl-1-butene, 3-methyl-1-butene, 2-methyl-2-butene, 4-methyl-1-pentene and mixtures thereof. The most preferred C₄ to C₇ monoolefin monomer is isobutylene.

The preferred C₄ to C₁₄ multiolefin monomer may be selected from isoprene, butadiene, 2-methylbutadiene, 2,4-dimethylbutadiene, piperylene, 3-methyl-1,3-pentadiene, 2,4-hexadiene, 2-neopentylbutadiene, 2-methyl-1,5-hexadiene, 2,5-dimethyl-2,4-hexadiene, 2-methyl-1,4-pentadiene, 2-methyl-1,6-heptadiene, cyclopentadiene, methylcyclopentadiene, cyclohexadiene, 1-vinyl-cyclohexadiene and mixtures thereof. The most preferred C₄ to C₁₄ multiolefin monomer is isoprene.

The monomer mixture used to prepare suitable butyl rubber polymers for the present invention may contain crosslinking agents, transfer agents and further monomers, provided that the further monomers are copolymerizable with the other monomers in the monomer mixture. Suitable crosslinking agents, transfer agents and monomers include all known to those skilled in the art.

Butyl rubber polymers useful in the present invention can be prepared by any process known in the art and accordingly the process is not restricted to a special process of polymerizing the monomer mixture. Such processes are well known to those skilled in the art and usually include contacting the monomer mixture described above with a catalyst system. The polymerization can be conducted at a temperature conventional in the production of butyl polymers, e.g., in the range of from −100° C. to +50° C. The polymer may be produced by polymerization in solution or by a slurry polymerization method. Polymerization can be conducted in suspension (the slurry method), see, for example, Ullmann's Encyclopedia of Industrial Chemistry (Fifth, Completely Revised Edition, Volume A23; Editors Elvers et al., 290-292). On an industrial scale, butyl rubber is produced almost exclusively as isobutene/isoprene copolymer by cationic solution polymerization at low temperatures; see, for example, Kirk-Othmer, Encyclopedia of Chemical Technology, 2nd ed., Vol. 7, page 688, lnterscience Publ., New York/London/Sydney, 1965 and Winnacker-Kuchler, Chemische Technologie, 4th Edition, Vol. 6, pages 550-555, Carl Hanser Verlag, Munchen/Wien, 1962. The expression “butyl rubber” can also denote a halogenated butyl rubber.

According to the present invention, butyl rubber can be grafted with a grafting material, such as an ethylenically unsaturated carboxylic acid or derivatives thereof (including, esters, amides, anhydrides). According to the present invention, grafting may be accomplished by any conventional and known grafting process. Suitable grafting materials include maleic anhydride, chloromaleic anhydride, itaconic anhydride, hemic anhydride or the corresponding dicarboxylic acid, such as maleic acid or fumaric acid, or their esters. The grafting material is generally used in an amount ranging from 0.1 to 15, based on 100 parts of butyl rubber (phr), preferably in an amount ranging from 1 to 10 phr, more preferably ranging from 3 to 5 phr.

Preferably, grafting of the butyl rubber is performed by free radical induced grafting without the use of a solvent. The free radical grafting is preferably carried out using free radical initiators such as peroxides and hydroperoxides, preferably those having a boiling point greater than about 100° C. Suitable free radical initiators include, but are not limited to, di-lauroyl peroxide, 2,5-dimethyl-2,5-di(t-butylperoxy)-hexyne-3 (Luperox® 130, Arkema Group) or its hexane analogue, 2,5-dimethyl-2,5-di(t-butylperoxy)-hexane (Luperox® 101, Arkema Group), di-tertiary butyl peroxide and dicumyl peroxide. Free radical induced grafting of the butyl rubber can also be carried out by radiation, shear or thermal decomposition.

The initiator is generally used at a level of between about 0.1 phr to about 5 phr, based on 100 phr of butyl rubber, preferably at a level of between about 0.3 to about 3 phr, more preferably at a level of between about 0.5 to about I phr. The grafting material and free radical initiator are generally used in a weight ratio range of 1:1 to 20:1, preferably 5:1 to 10:1.

The initiator degradation and/or grafting can be performed by any process known to those skilled in the art; preferably it is carried out at a temperature range of between 50 to 250° C., preferably from between 160 to 200° C. An inert atmosphere is preferably used. The total time for degradation and grafting will usually range from 1 to 30 minutes. The degradation and grafting can be carried out in an internal mixer, two-roll mill, single screw extruder, twin screw extruder or any combination thereof. In general, it is preferred to conduct high sheer mixing of the polymer and grafting agent in the presence of a free radical initiator.

The grafted butyl polymers prepared according to the present invention are liquid and generally exhibit a number molecular weight average (Mₙ) in the range of from about 200,000 to about 20,000, more preferably from about 150,000 to about 30,000, yet more preferably from about 100,000 to about 40,000, even more preferably from about 95,000 to about 50,000 as determined by GPC (gel permeation chromatography).

The polydispersity index (PDI) is the ratio of M_{w} to Mₙ and is preferably in the range of from about 1 to 3, more preferably from about 1 to 2.5, yet more preferably from about 1 to 2.

The liquid grafted polymers prepared according to the present invention can be cured in the presence of multifunctional amines or diols. Suitable multifunctional amines are of the formula NₓRN_{y}, wherein x and y are the same or different integer, having a value of 2 or more than 2 and wherein R is any known linear, cyclic or branched, organic or inorganic spacer. Suitable multifunctional amines include ethylenediamine, trimethylenediamine, tetramethylenediamine, hexamethylenediamine, octamethylenediamine, hexamethylenebis(2-amino-propyl)amine, diethylenetriamine, triethylenetetramine, polyethylene-polyamine, tris(2-aminoethyl)amine, 4,4′-methylenebis(cyclohexylamine), N,N′-bis(2-aminoethyl)-1,3-propanediamine, N,N′-bis(3-aminopropyl)-1,4-butane-diamine, N,N′-bis(3-aminopropyl)-ethylenediamine, N,N′-bis(3-aminopropyl)-1,3-propanediamine, 1,3-cyclo-hexanebis(methylamine), phenylenediamine, xylylenediamine, β-(4-amino-phenyl)ethylamine, diaminotoluene, diaminoanthracene, diaminonaphthalene, diaminostyrene, methylenedianiline, 2,4-bis(4-aminobenzyl)aniline, aminophenyl ether, triethylenetetraamine, tetraethylenepentaamine, pentaethylenehexamine, benzenetetraamine, 1,6-diaminoahexane, bis(4-aminophenyl) methane and 1,3-phenylenediamine.

Compositions according to the present invention can be useful in a variety of applications, including injection molded fuel cell gaskets, adhesives, sealants or as polyurethane substrates.

### EXAMPLES

GPC analysis was performed with the use of a Waters Alliance 2690 Separations Module and Viscotek Model 300 Triple Detector Array. GPC samples were prepared by dissolution in tetrahydrofuran (THF). Maleic anhydride (MAn) content was determined with use of a calibrated Fourier Transform-Infrared (FT-IR) procedure. Calibration data was generated by casting IIR films from hexane solutions containing known amounts of 2-dodecen-1-yl-succinic anhydride (DDSA). The absorbance of the principal carbonyl resonance derived from the anhydride (1830 cm⁻¹ to 1749 cm⁻¹) was normalized for film thickness using a polymer backbone resonance (978 cm⁻¹ to 893 cm⁻¹) to develop a linear calibration for wt % of anhydride functionality with graft modified-IIR.

The extent of crosslinking was determined through gel content analysis. A known mass of sample was extracted by toluene at reflux from a wire mesh bag for three hours, after which the bag was dried to constant weight. Gel contents are reported as the weight percent of unextracted polymer.

The maleation/degradation reactions of Examples 2-10 were carried out according to the following procedure: IIR (see Table 1 and Table 2) was mixed with the required amount of DCP (dicumylperoxide, Aldrich Chemical Co.) or Luperox® 130 (2,5-dimethyl-2,5-di(t-butylperoxy)-hexyne-3, Arkema Group) and maleic anhydride (MAn) as noted in Table 1 in a Haake batch mixer at room temperature. The resulting masterbatch was then reacted in an Atlas Laboratories Minimixer at 160° or 200° C. to generate IIR-g-MAn.

The resulting maleated butyl product (1-2 g) was dissolved in hexanes (˜15 ml), then precipitated from acetone (˜150 ml). Low molecular weight samples were left to sit for 12 hours after precipitation to facilitate polymer isolation. All materials were dried under vacuum, and the anhydride content was determined using a calibrated FT-IR procedure.

A series of GPC experiments were completed to determine the extent to which small amounts of peroxide reduce the molecular weight of IIR. Examples 1-10 investigate the role of peroxide and MAn in the degradation of IIR. As can be seen from the data presented in Table 1, a combination of MAn and DCP yields the most significant amount of degradation.

TABLE 1

| | | | Mₙ (number | M_{w} (weight |
|---|---|---|---|---|
| | | | average | average |
| | | Temperature | molecular | molecular |
| Example | | (° C.) | weight) | weight) |
| 1 | IIR* | no reaction | 261,000 | 573,000 |
| 2 | IIR* | 180 | 242,000 | 548,000 |
| 3 | IIR* | 200 | 246,000 | 542,000 |
| 4 | IIR/MAn 5 wt. %/DCP | 200 | 94,400 | 268,000 |
| | 0.50 wt. % | | | |
| 5 | IIR/DCP 0.50 wt. % | 200 | 126,000 | 344,000 |
| 6 | IIR/DCP 0.25 wt. % | 200 | 181,000 | 487,000 |
| 7 | IIR/MAn 5 wt. % | 200 | 230,000 | 596,000 |

IIR* is unreacted butyl.
All degradation times = 10 minutes.

Bound polymer content was determined by treatment of MAn grafted butyl rubber with an excess of aminopropyltrimethoxysilane. To this end, a 2 wt % solution of maleated-IIR in toluene was charged to a mechanically-stirred glass reactor. 3-aminopropyltrimethoxysilane (APTMS, 3 eq. relative to grafted anhydride) was then added and the mixture refluxed for 30 min. After cooling, a sample was taken for FT-IR analysis and then silica (HiSil® 233, PPG Industries, 40 wt. %) was added. The mixture was refluxed for 20 min and precipitated from acetone (˜200 mL). The recovered material was dried under vacuum to constant weight, and charged to a wire mesh bag. The sample was then extracted with boiling toluene for 2 hours, dried, and reweighed. Data were recorded as the weight percent of insoluble polymer after accounting for the silica retained in the sample. The imidization results listed in Table 1 show that silica binding rendered insoluble a very high fraction of the modified polymers, which suggests that the composition distribution of grafts amongst the chains is relatively uniform.

In Examples 9-10, crosslinking reactions were carried out according to the following procedure: IIR-g-MAn (˜1 g) prepared according to the process discussed above (Example 4) with the required amount of peroxide and maleic anhydride as indicated in Table 2, was dissolved in toluene (50 ml) along with a ⅓ equivalent of tris(2-aminoethyl)amine relative to grafted anhydride content. The solution was heated to about 100° C. for 30 minutes, and the polymer was isolated by precipitation from acetone, and dried under vacuum.

As illustrated above, treatment of IIR with MAn and DCP or L130 results in grafting of MAn onto the IIR polymer backbone. In Example 8, the IIR-g-MAn was treated with aminopropyltrimethoxysilane which generated an imide derivative. The material possessed trimethoxysilane functionalities which can react with the surface of silica. On treatment of this material with silica, the bound polymer content was found to be 89 wt. %. The bound polymer content was determined by Soxhiet extraction of the silica reacted material in refluxing hexanes for 1 hour.

The results listed in Table 2 show that silica binding of Example 8 rendered insoluble a very high fraction of the modified polymer, which suggests that the composition distribution of grafts among the chains is relatively uniform.

TABLE 2

| | | | Grafted | Bound | Cross- |
|---|---|---|---|---|---|
| Exam- | | Temp. | MAn | Polymer | linked |
| ple | | ° C. | wt. % | wt: % | Polymer |
| 8 | IIR/MAn 5 wt. %/DCP | 200 | 0.25 | 89 | ** |
| | 0.50 wt, % | | | | |
| 9 | IIR/MAn 5 wt. %/L130 | 200 | 0.91 | ** | 83 |
| | 1 wt. % | | | | |
| 10 | IIR/MAn 5 wt. %/L130 | 160 | 0.64 | ** | 99 |
| | 1 wt. % | | | | |

** Not Measured

The Examples demonstate the ability to simultaneously degrade and maleate commercial IIR (RB 301), supplied in baled form, to generate a liquid IIR analogue (IIR-g-MAn) which can be cured in the presence of multi-functional amines. The present invention allows the conversion of baled-IIR rubber into a free flowing maleated liquid analogue.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A grafted liquid polymer comprising, a polymer of a C₄ to C₇ monoolefin monomer and a C₄ to C₁₄ multiolefin monomer, a grafting material and a free radical initiator.

2. The grafted liquid polymer according to claim 1, wherein the C₄ to C₇ monoolefin monomer is selected from isobutylene, 2-methyl-1-butene, 3-methyl-1-butene, 2-methyl-2-butene, 4-methyl-1-pentene and mixtures thereof.

3. The grafted liquid polymer according to claim 1, wherein the C₄ to C₄ multiolefin monomer is selected from isoprene, butadiene, 2-methyl-butadiene, 2,4-dimethylbutadiene, piperylene, 3-methyl-1,3-pentadiene, 2,4-hexadiene, 2-neopentylbutadiene, 2-methyl-1,5-hexadiene, 2,5-dimethyl-2,4-hexadiene, 2-methyl-1,4-pentadiene, 2-methyl-1,6-hepta-diene, cyclopentadiene, methylcyclopentadiene, cyclohexadiene, 1-vinyl-cyclohexadiene and mixtures thereof.

4. The grafted liquid polymer according to claim 1, wherein the grafted liquid polymer has a number average molecular weight (Mₙ) of from 150,000 to 30,000.

5. The grafted liquid polymer according to claim 4, wherein the grafted liquid polymer has a polydispersity index (PDI) of from 1 to 3.

6. The grafted liquid polymer according to claim 1, wherein the grafting material is an ethylenically unsaturated carboxylic acid(s) or a derivative(s) thereof.

7. The grafted liquid polymer according to claim 1, wherein the grafting material is maleic anhydride.

8. The grafted liquid polymer according to claim 1, wherein the free radical initiator is an organic peroxide or an organic hydroperoxide.

9. The grafted liquid polymer according to claim 1, wherein the free radical initator is selected from the group consisting of di-lauroyl peroxide, 2,5-dimethyl-2,5-di(t-butylperoxy)-hexyne-3, 2,5-dimethyl-2,5-di(t-butylperoxy)-hexane, di-tertiary butyl peroxide and dicumyl peroxide.

10. A cured compound comprising a grafted liquid polymer according to claim 1 and a multifunctional amine curing agent.

11. A cured compound according to claim 10, wherein the multifunctional amine curing agent is of the formula:
NₓRN_{y}
wherein, X is an integer of 2 or more, Y is an integer of 2 or more, and R is a linear, cyclic or branched organic or inorganic spacer.

12. A process for preparing a liquid graft-modified polymer comprising reacting a polymer of a C₄ to C₇ monoolefin monomer and a C₄ to C₁₄ multiolefin monomer in the presence of a grafting material and a free radical initiator.

13. The process according to claim 12, wherein the C₄ to C₇ monoolefin monomer is selected from isobutylene, 2-methyl-1-butene, 3-methyl-1-butene, 2-methyl-2-butene, 4-methyl-1-pentene and mixtures thereof.

14. The process according to claim 12, wherein the C₄ to C₁₄ multiolefin monomer is selected from isoprene, butadiene, 2-methylbutadiene, 2,4-dimethylbutadiene, piperylene, 3-methyl-1,3-pentadiene, 2,4-hexadiene, 2-neopentylbutadiene, 2-methyl-1,5-hexadiene, 2,5-dimethyl-2,4-hexa-diene, 2-methyl-1,4-pentadiene, 2-methyl-1,6-heptadiene, cyclopenta-diene, methylcyclopentadiene, cyclohexadiene, 1-vinyl-cyclohexadiene and mixtures thereof.

15. The process according to claim 12 wherein the grafted liquid polymer has a number average molecular weight (Mₙ) of from 150,000 to 30,000.

16. The process according to claim 15, wherein the grafted liquid polymer has a polydispersity index (PDI) of from 1 to 3.

17. The process according to claim 12, wherein the grafting material is an ethylenically unsaturated carboxylic acid(s) or a derivative(s) thereof.

18. The process according to claim 12, wherein the grafting material is maleic anhydride.

19. The process according to claim 12, wherein the free radical initiator is an organic peroxide or an organic hydroperoxide.

20. The process according to claim 12, wherein the free radical initiator is selected from the group consisting of di-lauroyl peroxide, 2,5-dimethyl-2,5-di(t-butylperoxy)-hexyne-3, 2,5-dimethyl-2,5-di(t-butylperoxy)-hexane, di-tertiary butyl peroxide and dicumyl peroxide.

21. A process for degrading a non-liquid polymer to a grafted liquid polymer, the process comprising reacting the non-liquid polymer of a C₄ to C₇ monoolefin monomer and a C₄to C₁₄ multiolefin monomer in the presence of a grafting material and a free radical initiator to form the grafted liquid polymer.

22. A process for preparing a cured compound comprising reacting a polymer of a C₄ to C₇ monoolefin monomer and a C₄ to C₁₄ multiolefin monomer in the presence of a grafting material and a free radical initiator to form a grafted liquid polymer and then curing the grafted liquid polymer in the presence of a multifunctional amine curing agent.

23. A process according to claim 22 wherein the multifunctional amine curing agent is of the formula:
NₓRN_{y}
wherein X is an integer of 2 or more, Y is an integer of 2 or more, and R is a linear, cyclic or branched organic or inorganic spacer.
